(19) United States
(12) Patent Application Publication
(10) Pub. No.: US 2026/0044891 A1
(43) Pub. Date: Feb. 12, 2026

(54) SYSTEMS AND METHODS FOR GENERATING ALTERNATIVE THREE-DIMENSIONAL VEHICLE MODELS AND/OR ENABLING PHYSICAL VEHICLE MODIFICATIONS OR REPAIRS USING SAME

(71) Applicants: Ahmed Farouk SHAABAN, South Barrington, IL (US); Venkat THANDRA, South Barrington, IL (US); Noah SHAABAN, South Barrington, IL (US); Maxwell GRANT, Carpentersville, IL (US)

(72) Inventors: Ahmed Farouk SHAABAN, South Barrington, IL (US); Venkat THANDRA, South Barrington, IL (US); Noah SHAABAN, South Barrington, IL (US); Maxwell GRANT, Carpentersville, IL (US)

(21) Appl. No.: 19/294,200

(22) Filed: Aug. 7, 2025

Related U.S. Application Data
(60) Provisional application No. 63/681,728, filed on Aug. 9, 2024.

(51) Int. Cl. G06Q 30/0601; G06Q 10/20; H04W 4/029

(52) U.S. Cl. CPC G06Q 30/06434; G06Q 10/20; H04W 4/029

(57) ABSTRACT

Systems and methods for generating modified virtual three-dimensional builds of vehicles are disclosed herein. In an embodiment, the method includes receiving first user input regarding a vehicle from a remote user terminal, generating a virtual three-dimensional build of the vehicle on a user interface of the remote user terminal using a build code including a plurality of parts codes, receiving second user input from the remote user terminal regarding at least one modification to the virtual three-dimensional build using an alternative part which replaces a current part on the vehicle, altering the build code by replacing a current parts code for the current part with an alternative parts code for the alternative part, and regenerating a modified virtual three-dimensional build on the user interface of the user terminal using the altered build code, the modified virtual three-dimensional build showing the alternative part in place of the current part.

### RELATED APPLICATION

This application claims priority to U.S. Provisional Application No. 63/681,728, filed Aug. 9, 2024 and entitled “Systems and Methods Enabling Automobile Modifications and Repairs,” the entire contents of which is incorporated herein by reference and relied upon.

### BACKGROUND

### Technical Field

The present disclosure generally relates to systems and methods for generating alternative three-dimensional vehicle models and/or enabling physical vehicle modifications or repairs using same.

### Background Information

Typically, when a vehicle owner or a repair shop wants to repair or modify a vehicle, the owner or repair shop needs to visit multiple retailers or contact suppliers directly to locate parts. The process is even more complicated when a vehicle already has or requires aftermarket modifications. The vehicle owner or repair shop may be unsure whether certain parts are compatible or sized and shaped appropriately for the vehicle.

### SUMMARY

The present disclosure provides systems and methods for generating alternative three-dimensional vehicle models with alternative or modified parts. The generated three-dimensional models have practical applications such as determining and visualizing part compatibility prior to purchase and install. The systems and methods disclosed herein can also be used to enable an online platform which requires minimal processing resources and memory storage to propose and review modifications to a vehicle and/or enable a search for, comparison of and/or purchase of modified parts and accessories through an intuitive interface that accounts for aftermarket modifications.

A first aspect of the present disclosure is to provide a method for generating modified virtual three-dimensional builds of vehicles. The method includes receiving a first user input regarding a vehicle from a remote user terminal operated by a remote user, generating a virtual three-dimensional build of the vehicle on a user interface of the remote user terminal using a build code including a plurality of parts codes, receiving a second user input from the remote user terminal regarding at least one modification to the virtual three-dimensional build using an alternative part which replaces a current part on the vehicle, altering the build code by replacing a current parts code for the current part with an alternative parts code for the alternative part, and regenerating a modified virtual three-dimensional build on the user interface of the user terminal using the altered build code, the modified virtual three-dimensional build showing the alternative part in place of the current part.

A second aspect of the present disclosure is to provide a method for generating modified virtual three-dimensional builds of vehicles. The method includes generating a virtual three-dimensional build of a vehicle on a user interface of a remote user terminal using a build code including a plurality of parts codes, the plurality of parts codes including an anchor coordinate and an object scale coordinate, determining a plurality of alternative parts that can replace a current part using the anchor coordinate of the current part and the object scale coordinate of the alternative part, enabling selection of the plurality of alternative parts along the virtual three-dimensional build of the vehicle, and upon selection of one of the plurality of alternative parts, regenerating a modified virtual three-dimensional build on the user interface, the modified virtual three-dimensional build showing the alternative part in place of the previous part.

A third aspect of the present disclosure is to provide a method for generating modified virtual three-dimensional builds of vehicles. The method includes receiving a first user input regarding a vehicle from a remote user terminal operated by a remote user, generating a virtual three-dimensional build of the vehicle on a user interface of the remote user terminal using a build code from a build database, receiving a second user input from the remote user terminal regarding at least one modification to the virtual three-dimensional build using an alternative part which replaces a current part on the vehicle, regenerating a modified virtual three-dimensional build of the vehicle on the user interface of the user terminal, the modified virtual three-dimensional build showing the alternative part in place of the current part, replacing the build code in the build database with an altered build code including a parts code for the alternative part, searching for availability of the alternative part for purchase, and enabling purchase of the alternative part by the user using the user terminal.

A fourth aspect of the present disclosure is to provide a method for enabling vehicle modifications and repairs using generated three-dimensional vehicle models. The method includes receiving a first user input regarding a vehicle from a remote user terminal operated by a remote user, generating a virtual three-dimensional build of the vehicle on a user interface of the remote user terminal, receiving a second user input from the remote user terminal regarding at least one modification to the vehicle using an alternative part which replaces a previous part on the vehicle, regenerating a modified virtual three-dimensional build of the vehicle on the user interface of the user terminal, the modified virtual three-dimensional build showing the alternative part in place of the previous part, adjusting parameters stored in a build database that replaces previous coding for the previous part with replacement coding for the alternative part, using the replacement coding to search for availability of the alternative part for purchase, and enabling purchase of the alternative part by the user using the user terminal.

A fifth aspect of the present disclosure is to provide computer-implemented method of training a neural network to identify vehicle modifications. The method includes receiving one or more first digital images that captures one or more original parts of an vehicle, receiving one or more second digital images that captures one or more modified parts that replace the one or more original parts of the vehicle, creating a first training set comprising the one or more first digital images, training the neural network in a first stage using the first training set, creating a second training set comprising the one or more second digital images, training the neural network in a second stage using the second training set.

A sixth aspect of the present disclosure is to provide another method for enabling vehicle modifications and repairs. The method includes receiving a first user input regarding a vehicle from a remote user terminal operated by a remote user, generating a virtual three-dimensional build of the vehicle on a user interface of the remote user terminal, receiving a second user input from the remote user terminal regarding at least one modification to the vehicle using an alternative part which replaces a previous part on the vehicle, regenerating a modified virtual three-dimensional build of the vehicle on the user interface of the user terminal, the modified virtual three-dimensional build showing the alternative part in place of the previous part, and adjusting parameters stored in a build database replace previous coding for the previous part with replacement coding for the alternative part.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system for generating alternative three-dimensional vehicle models and/or enabling physical vehicle modifications or repairs using same;

FIG. 2 illustrates an example embodiment of a system for generating alternative three-dimensional vehicle models and/or enabling physical vehicle modifications or repairs using same;

FIG. 3 illustrates an example embodiment of a user terminal which can be used in the system of FIGS. 1 and 2;

FIG. 4 illustrates an example embodiment of a method of enabling generation of alternative three-dimensional vehicle models using the system of FIGS. 1 and 2;

FIG. 5 illustrates an example embodiment of a method of executing an online platform using the method of FIG. 4;

FIG. 6 illustrates an example embodiment of a user interface generated during the methods of FIGS. 4 and 5;

FIG. 7 illustrates an example embodiment of another user interface generated during the methods of FIGS. 4 and 5;

FIG. 8 illustrates an example embodiment of a list of identifiers for different parts of a three-dimensional vehicle model; and

FIG. 9 illustrates an example embodiment of coding to replace an initial part with an alternative part in a build code.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

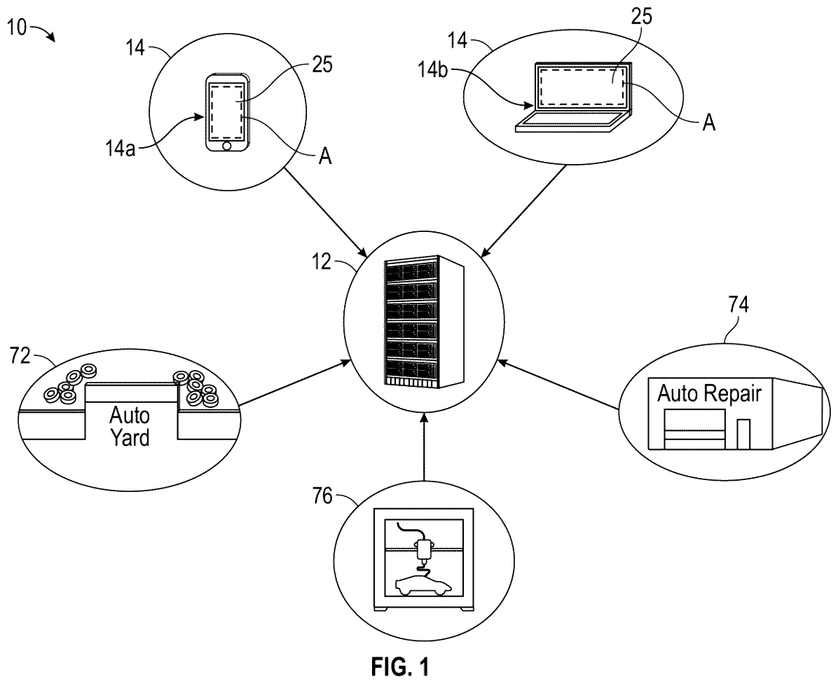

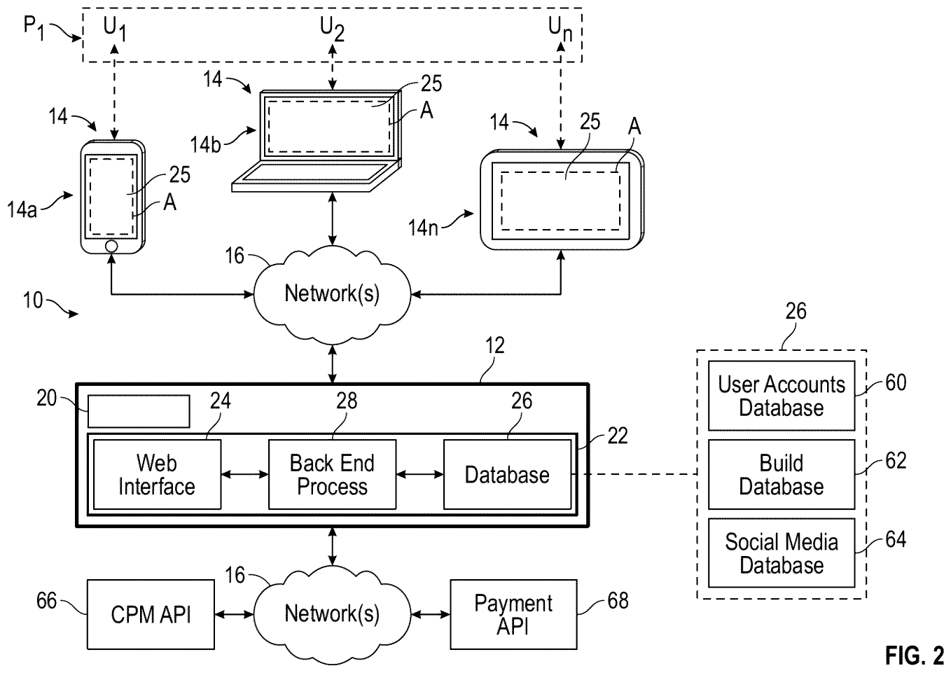

FIGS. 1 and 2 illustrate an example embodiment of a system 10 for generating alternative three-dimensional vehicle models and/or enabling physical vehicle modifications or repairs using the three-dimensional vehicle models. Although this disclosure provides applications using certain types of vehicles, those of ordinary skill in the art will recognize from this disclosure the advantages of implementing the same principles for other types of vehicles. For example, the vehicle can be a car, truck, motorcycle, moped, ATV, boat, airplane or another type.

In the illustrated embodiment, the system 10 includes a central server 12 and one or more user terminals 14 operated by one or more users U1, U2 . . . . Un. The central server 12 is configured to wirelessly communicate with each of the user terminals 14 via a network 16 to enable the user terminals 14 to function as disclosed herein.

Each of the plurality of user terminals 14 can be, for example, a cellular phone, a tablet, a personal computer, or another personal electronic device. Here, the plurality of user terminals 14 includes a first user terminal 14a, a second user terminal 14b, and an nth user terminal 14n. Each user terminal 14 can be controlled by a distinct user U1, U2 . . . . Un (e.g., a first user U1 controls the first user terminal 14a, a second user U2 controls the second user terminal 14b, and an nth user Un controls the nth user terminal 14n). As used herein, each of the users U1, U2 . . . . Un can also be referred to generally as a user U. Any user U can log into the system 10 and access the functionality disclosed herein. For example, the user U can be an individual seeking to modify a vehicle and/or locate and purchase parts, an employee of a repair shop or vehicle dealer seeking to modify a vehicle and/or locate and purchase parts, or an individual seeking to compare various designs in relation to the cost and appearance of specific parts related to the designs.

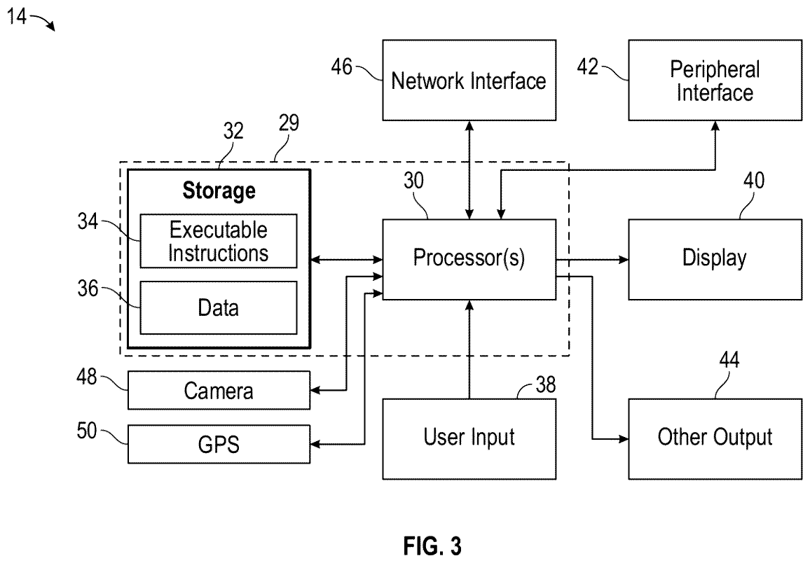

FIG. 3 illustrates a representative diagram of an example embodiment of a user terminal 14. As illustrated, a user terminal 14 can include a terminal controller 29 including a terminal processor 30 and a terminal memory 32. The terminal processor 30 is configured to execute instructions programmed into and/or stored by the terminal memory 32. The instructions can be received from and/or periodically updated by the web interface 24 of the central server 12 in accordance with the methods discussed herein. As described in more detail below, many of the functions described herein can be stored as instructions in the terminal memory 32 and executed by the terminal processor 30.

In an embodiment, the terminal processor 30 can comprise one or more of a microprocessor, microcontroller, digital signal processor, co-processor or the like or combinations thereof capable of executing stored instructions 34 and operating upon stored data 36, wherein the instructions 34 and/or stored data 36 are stored by the terminal memory 32. The terminal memory 32 can comprise one or more devices such as volatile or nonvolatile memory, for example, random access memory (RAM) or read only memory (ROM). Further, the terminal memory 32 can be embodied in a variety of forms, such as a hard drive, optical disc drive, etc. In an embodiment, some of the processing techniques described herein are implemented as a combination of executable instructions 34 and data 36 stored within the terminal memory 32. The terminal memory 32 can be stored on a mobile device.

As illustrated, each of the plurality of user terminals 14 includes a user input device 38, a display 40, a peripheral interface 42, an output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25. The peripheral interface 42 can include the hardware, firmware, and/or other software necessary for communication with various peripheral devices, such as media drives (e.g., magnetic disk or optical disk drives), other processing devices, or another input source used as described herein. Likewise, the other output device 44 can optionally include similar media drive mechanisms, other processing devices or other output destinations capable of providing information to a user of the user terminal 14, such as speakers, LEDs, tactile outputs, or 3D printers, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

In the illustrated embodiment, the user terminal 14 includes a camera 48. The camera 48 is configured to record and store digital images and/or videos. In an embodiment, the application A discussed herein is configured to access the camera on the user terminal 14 without the user U having to navigate to a separate camera application and open the separate camera application to gain access to the camera. The application A can be further configured to determine whether digital images and/or videos include deficiencies such as being too bright or dark, too blurry, etc. If a digital image recorded by the camera 48 is deficient, the application A will instruct the user to retake the image with the camera 48.

In the illustrated embodiment, the user terminal 14 includes a global positioning system (“GPS”) device 50. The GPS device 50 can be used, for example, to record past or present data regarding the physical location of the user terminal 14, which can be used to determine the physical locations of the user U who typically uses the user terminal 14. In an embodiment, the application A discussed herein and downloaded to the user terminal 14 is configured to automatically access the user U's past or present locations without the user U having to separately navigate and open up a separate GPS application to retrieve the data. In an embodiment, the user U of a user terminal 14 can be required to enable access to the GPS device 50 for the system 10 to determine and/or utilize the user U's past or present locations. In an embodiment, relevant data from the GPS device 50 can be stored as data 36 within the terminal memory 32 and accessed by the central server 12 as needed.

While the user terminal 14 has been described as one form for implementing the techniques described herein, those having ordinary skill in the art will appreciate from this disclosure that other functionally equivalent techniques can be employed. For example, some or all of the functionality implemented via executable instructions can also be implemented using firmware and/or hardware devices such as application specific integrated circuits (ASICs), programmable logic arrays, state machines, etc. Further, other implementations of the user terminal 14 can include a greater or lesser numbers of components than those illustrated. Further still, although a single user terminal 14 is illustrated in FIG. 3, it should be understood from this disclosure that a combination of such devices can be configured to operate in conjunction (for example, using known networking techniques) to implement the methods described herein.

Referring again to FIGS. 1 and 2, the central server 12 is a central controller including one or more server computers, database servers and/or other types of computing devices, particularly in connection with, for example, the implementation of websites and/or enterprise software. The central server 12 can further comprise a central processor 20 and a central memory 22. The central processor 20 is configured to execute instructions programmed into and/or stored by the central memory 22. In an embodiment, the central processor 20 can comprise one or more of a microprocessor, microcontroller, digital signal processor, co-processor or the like or combinations thereof capable of executing stored instructions and operating upon stored data, wherein the instructions and/or data are stored by the central memory 22. The central memory 22 can comprise one or more devices such as volatile or nonvolatile memory, for example, random access memory (RAM) or read only memory (ROM). Further, the central memory 22 can be embodied in a variety of forms, such as a hard drive, optical disc drive, etc. As described in more detail below, the steps of the methods described herein can be stored as instructions in the central memory 22 and executed by the central processor 20.

In the illustrated embodiment, the central memory 22 includes a web interface 24, a database 26, and back end processing instructions 28. Here, the web interface 24, the database 26, and the back end processing instructions 28 can be controlled or accessed by the central processor 20 implementing appropriate software programs by executing the back end processing instructions 28 or other instructions programmed into and/or stored by the central memory 22.

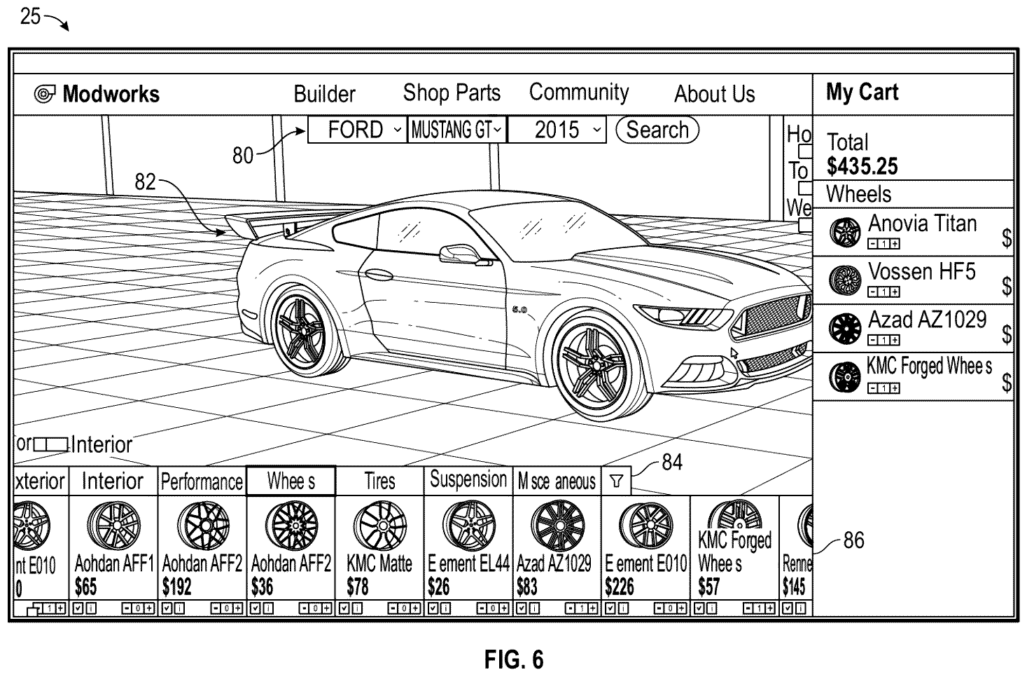

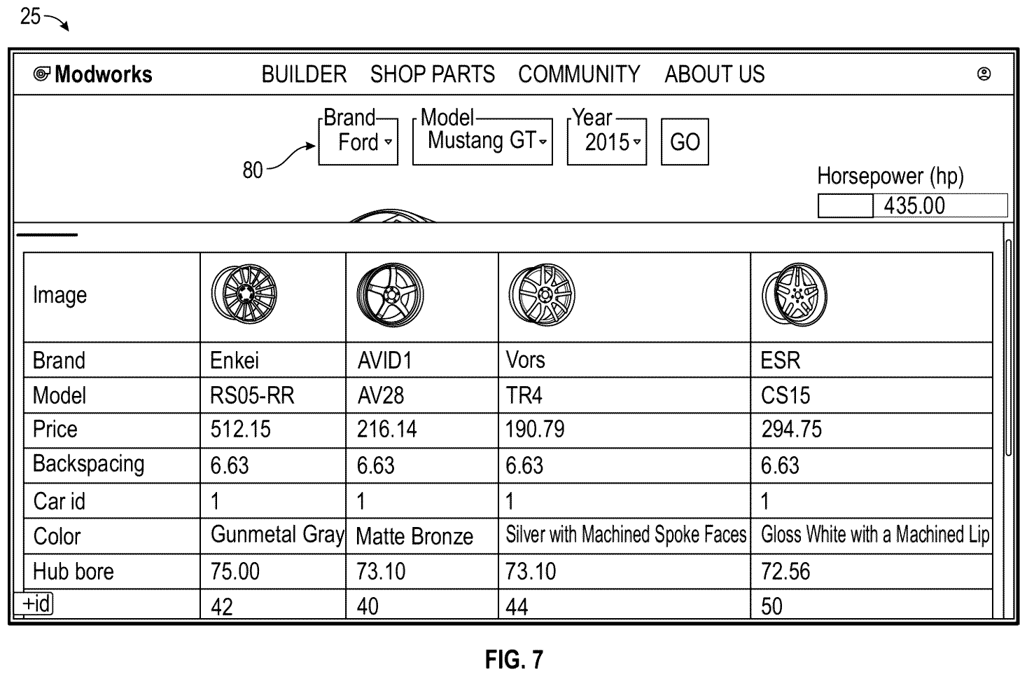

The web interface 24 can provide a graphical user interface (“GUI”) 25 that can be displayed on a terminal 14 for a user U, and can manage the transfer of data received from and sent to the GUI 25 on the terminal 14. In an embodiment, each user terminal 14 can include an application A comprising software downloaded to and executed by the terminal 14 to provide the GUI 25 and to manage communications with the central server 12. The application A can be downloaded to the user terminal 14 from the central server 12 or from some other source such as an application distribution platform. The application A is configured to access the camera 48 and/or GPS device 50 of the user terminal 14 without the user U having to separately open up and navigate separate applications to retrieve the data needed for the central server 12 to execute the methods discussed herein. FIGS. 6 to 7 illustrate example embodiments of GUIs 25 that can be displayed on a user terminal 14 using an application A as directed by the web interface 24.

In the illustrated embodiment, the database 26 includes a plurality of sub-databases, for example, a user accounts database 60, a build database 62 and a social media database 64. In an embodiment, one or more of the database 26 or sub-databases 60, 62, 64 can comprise a database management system (DBMS) operating on one or more suitable database server computers. Storage and use of the database 26 is discussed in more detail below.

The user accounts database 60 includes, for each user U, at least a username and a corresponding account password. The user account can also include identification codes for one or more vehicles associated with the user account, the location of the user U, previous photographs taken of the user U's vehicle with the camera 48 of the user terminal 14, and other information provided by the user U.

The build database 62 includes a build code for one or more virtual three-dimensional vehicle builds. Calling the build code generates a virtual three-dimensional model for a predetermined vehicle build defined by the build code. The build code 62 includes a plurality of parts codes for individual parts that make up the vehicle build. In an embodiment, one or more parts codes can include or link to a graphical part 3D file (e.g., .glb format) representing a respective part. In an embodiment, the parts codes include a part identifier (e.g., part name), one or more an anchor coordinate (e.g., an X, Y and Z anchor coordinate and/or relative dimensions), and one or more object scale coordinate (e.g., defining size/shape of the part defined by X, Y and Z coordinates and/or relative dimensions). The parts codes can include parts codes for original parts and/or parts codes for alternative parts reflecting after-market modifications as discussed in more detail below.

The build database 62 includes a plurality of build codes, and each of the plurality of build codes includes a plurality of different parts codes. The build database 62 can thus include parts codes for all parts of each vehicle build reflecting potential modifications for each and/or include or link to a graphical part 3D file (e.g., .glb format) representing each part. The build database 62 is configured to allow proposed build modifications based on a set of master instructions which call and edit the build code. In an embodiment, the system 10 uses the build databases 62 to configure a car or other vehicle as the user U adds, deletes, or modifies parts as discussed in more detail below.

The back end processing instructions 28 can be operatively coupled to both the web interface 24 and the database 26, and can be programmed into and/or stored by the central memory 22 and implemented by the central processor 20. In an embodiment, the back end processing instructions 28 can be executed by the central processor 20 to direct operations of the central server 12 as described below in further detail. For example, the central processor 20, executing the back end processing instructions 28, can manage the receipt, storage, maintenance, etc. of relevant data. Additionally, the central processor 20, executing the back end processing instructions 28, can develop the database 26 as discussed in more detail below.

In the illustrated embodiment, the central server 12 is configured to configured to communicate via the network 16 with a plurality of different databases (DBs) and application programming interfaces (APIs) including one or more of the user accounts database 60, the build database 62, the social media database 64, a car parts manufacturer API 66, a payment API 68. Those of ordinary skill in the art will recognize from this disclosure that other databases and APIs can also be incorporated into the systems and methods described herein.

In the illustrated embodiment, the central server 12 is configured to access a plurality of auto parts manufacturer data via one or more auto parts manufacturer APIs 36. The auto parts manufacturer data can include the part scale data that will be used by the central controller 20 to modify the build code and determine part compatibility of a modified build. In an embodiment, the system 10 can receive or link to graphical part 3D file supplied by the auto parts manufacturers via the auto parts manufacturer APIs 36.

In the illustrated embodiment, the central server 12 is configured to access one or more third party payment application via one or more payment API 38. The payment API 38 can be a third-party payment application accessed as known in the art. In an embodiment, the user U can used the payment API 38 to purchase parts upon reviewing and determining compatibility of the parts as described herein.

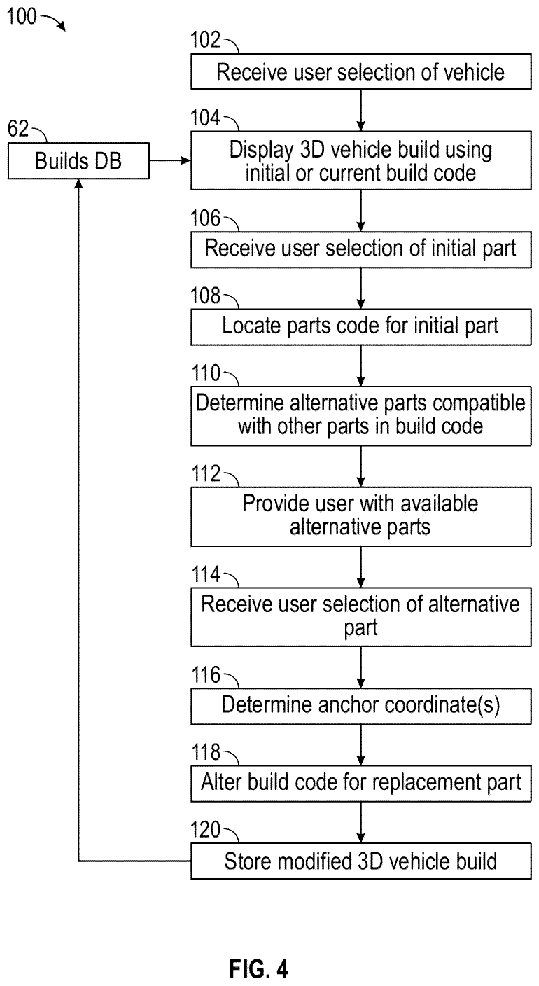

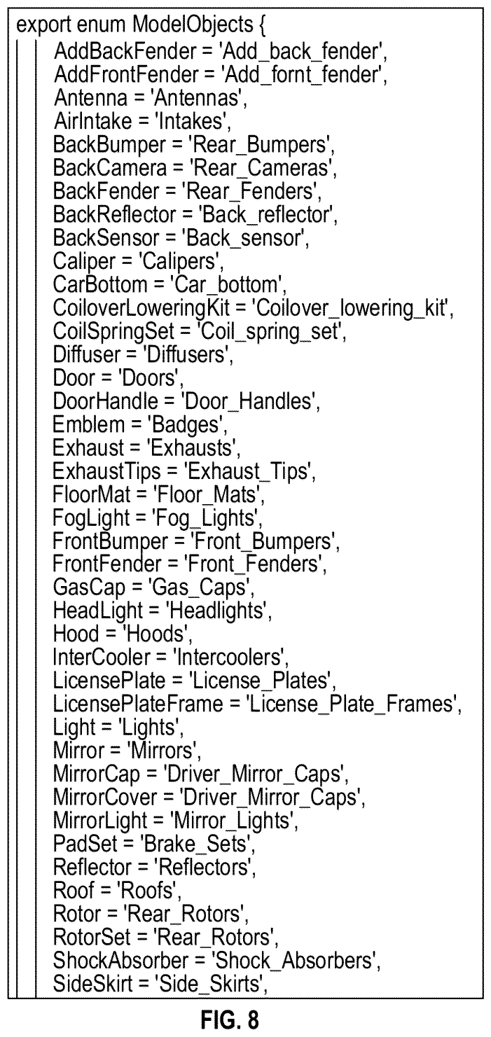

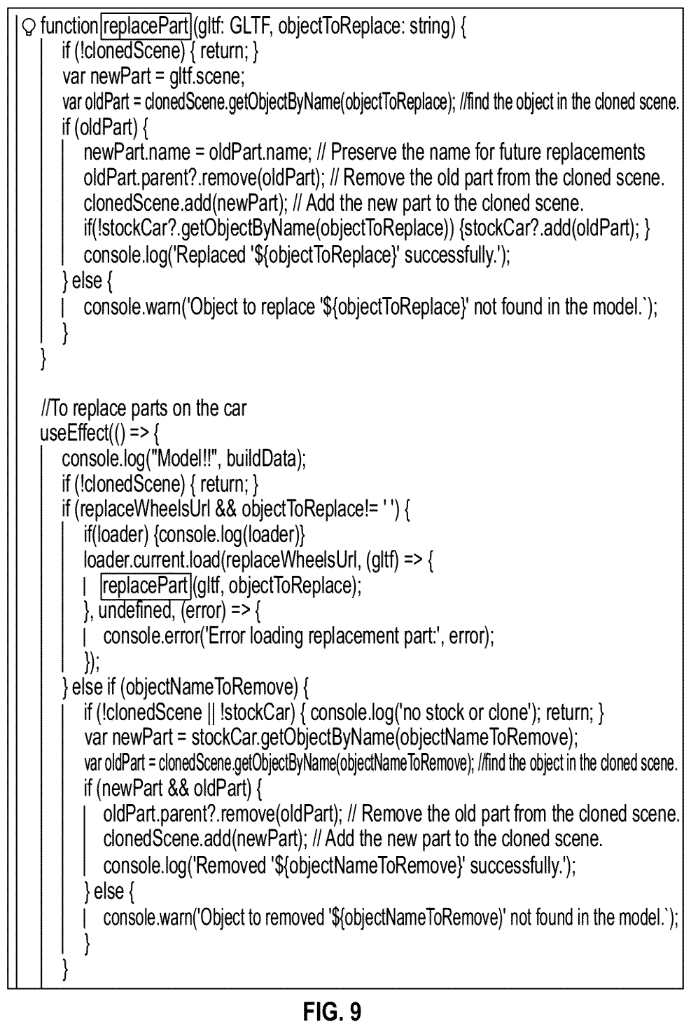

FIG. 4 illustrates an example embodiment of a method 100 for generating and storing alternative three-dimensional vehicle models. In an embodiment, one or more of the steps of the method 100 can be stored as instructions on the central memory 22 and executed by the central processor 20. In an embodiment, one or more of the steps of the method 100 can be stored as instructions on the terminal memory 32 and executed by the terminal processor 30. It should be understood by those of ordinary skill in the art from this disclosure that some of the steps described herein can be reordered or omitted without departing from the spirit or scope of method 100. FIGS. 6 and 7 further illustrate example embodiments of GUIs 25 generated on a user terminal during the method 100, and FIGS. 8 and 9 further illustrate example embodiments of how to execute certain steps of the method 100.

At step 102, the central server 12 receives a first user input from a remote user terminal 14 operated by a remote user U. The first user input can be a selection of a vehicle build. A vehicle build defines a vehicle model with a plurality of predetermined vehicle parts. The selection of the vehicle build can be a selection of a new vehicle build or a selection of a previously modified vehicle build. For example, in FIGS. 6 and 7, the GUI 25 enables the user U to select a new vehicle using a drop-down menu 80 enabling selection of a make, model and year (here, Ford Mustang GT, 2015). The user U can also select to load a previous model from a build code previously stored in the build database 62.

At step 104, the central server 12 generates a virtual three-dimensional build of the vehicle on the GUI 25 of the remote user terminal 14. The central server 12 generates a virtual three-dimensional build of the vehicle on the GUI 25 by calling the initial or stored build code for the vehicle.

FIG. 6 illustrates an example embodiment of a virtual three-dimensional build 82 of a vehicle. Here, the virtual three-dimensional build 82 is for a 2015 Ford® Mustang® GT. The virtual three-dimensional build 82 displays the vehicle in a three-dimensional format, preferably enabling the user U to rotate and zoom to view the vehicle from different angles and views as desired. Each of the parts corresponding to a parts code of the build code exists as a three-dimensional object taking up a three-dimensional space defined by relative coordinates and/or borders. In an embodiment, the user U can operate the GUI 25 to hide, display or highlight parts as needed, for example, to view parts that are not visible from outside the vehicle. In an embodiment, the user U can further cause movable parts (e.g., doors) to move within the three-dimensional space as needed.

In an embodiment, the central server 12 stores an initial build code for each make/model/year that can be selected via the menu 80 on the initial GUI 25. The initial build code includes a plurality of parts codes for the original parts of that vehicle build. The central server 12 can thus generate a three-dimensional image of the vehicle from the initial build code as seen in FIG. 6. If the selected vehicle is a modified vehicle, the central server 12 can retrieve the current build code for the modified vehicle from the build database 62 and generate a three-dimensional image of the vehicle from the current build code as seen in FIG. 6.

Thus, if the selected vehicle is a new vehicle, the central server 12 loads the selected vehicle using the initial build code for that vehicle. If the selected vehicle is a previously modified vehicle, the central server 12 loads the modified vehicle using the current build code for that vehicle from the build database 62. As discussed above, each part can be defined by a parts code that identifies a part identifier (e.g., part name), one or more an anchor coordinate (e.g., an X, Y and Z anchor coordinate and/or relative dimensions), and one or more object scale coordinate (e.g., size and shape of the part defined by X, Y and Z coordinates and/or relative dimensions). Each parts code can also include or link to a graphical part 3D file (e.g., .glb format) representing a respective part.

FIG. 8 illustrates an example embodiment of a list of identifiers for different parts. When saved as part of the build code, the part is saved under the predefined identifier, enabling replacement of parts in the build code as described in more detail below. That is, when a first part code is replaced with a different second part code in the build code, the second part code uses the same identifier as the first part code as seen for example in FIG. 9.

The anchor coordinate(s) define the positioning of the part within a three-dimensional coordinate system. The anchor coordinates serve as fixed reference points to position, orient and/or align the part within the virtual three-dimensional build. In an embodiment, the coordinate system includes orthogonal X, Y and Z axes, where the X-axis represents the longitudinal direction of the vehicle (front to rear), the Y axis represents the lateral direction (side to side), and the Z axis represents the vertical direction (top to bottom). The anchor coordinate(s) are defined points on the build and/or part geometry, which define mounting points such as a mounting hole center, a fastener boss, an edge midpoint, a surface normal intersection, or another geometrically significant feature. In an embodiment, the anchor coordinates are defined as X, Y and Z relative to the known reference frame, such as a reference frame for the vehicle build coordinate system or a coordinate system for a subassembly of the vehicle build. In an embodiment, a primary anchor point can serve as the origin for the component model, and a secondary anchor point can be used to constrain rotation or tilt. Where required, three or more non-collinear anchor coordinates may be used to fully define the spatial pose (e.g., pose and orientation) of the part. In an embodiment, the anchor coordinates can be defined by the graphical part 3D file for a part.

The object scale coordinates define the size and shape of the vehicle component within the three-dimensional coordinate system. The object scale coordinates provide dimensional references that allow the part to be scaled, resized or proportionally adjusted while maintaining geometric integrity. In an embodiment, the object scale coordinates are defined relative to an X, Y and Z coordinate system, with the part's geometry bounded by one or more scale-defining reference points. In an embodiment, the object scale coordinates can define a geometrically significant feature such as an extremity, a center point, a functional boundary, or a datum-defined reference plane. In an embodiment, the object scale coordinates can be expressed as absolute differences from a fixed origin, relative vectors from a designated anchor point, or parametric values that scale dynamically based on design constraints. In an embodiment, the anchor coordinate(s) can be combined with the object scale coordinate(s), or the object scale coordinates can reference or be made otherwise dependent on the anchor coordinates. In an embodiment, the object scale coordinates can be defined by the graphical part 3D file for a part.

At step 106, the user U selects an initial part from the three-dimensional build for the vehicle. The initial part selected by the user U can be a part which the user U wishes to change on the virtual three-dimensional build of the vehicle on the GUI 25 of the remote user terminal 14. In FIG. 6, the user U has selected “Wheels” within a first selection panel 84 to select the initial part, which enables the user U to select a particular type of wheel from a second selection panel 86. In another embodiment, the user U can select the part by clicking on the relevant portion of the virtual three-dimensional build 82 itself.

At step 108, the central server 12 locates the parts code for the selected part within the build code. In an embodiment, the central controller 20 uses a reference table to locate the parts code for the selected part. The reference table can indicate a line or section in the build code where the parts code can be found. In another embodiment, the central server 12 uses a word search of the build code to locate the identifier for the selected part. In an embodiment, the central server 12 locates the graphical part 3D file for the selected part.

At step 110, the central server 12 determines a plurality of alternative parts that can replace the selected part. More specifically, the central controller 20 determines alternative parts that are compatible with the current build 82 being displayed on the GUI 25 of the remote user terminal 14. In an embodiment, the central controller 20 uses a reference table or other directory to determine which alternative parts are compatible with the selected part. In an embodiment, the central controller 20 determines the size and/or location of the selected part using the parts code located for that part at step 108, and determines the alternative parts that are compatible with the selected part based on similar size and/or location as defined by the respective parts codes for the alternative parts.

In an embodiment, the central server 12 uses the size/shape of the alternative part to determine whether the alternative part is compatible with the current build being displayed on the GUI 25 of the remote user terminal 14. More specifically, the central server 12 uses the anchor coordinates of the initial part as the anchor coordinates for the potential alternative part. The central controller 20 then determines whether the size/shape of the alternative part will cause any portion of the alternative part to overlap with any portion of another part in the build if the alternative part is also anchored at the anchor coordinate for the initial part. That is, the central server 12 determines whether any other parts in the build code have overlapping coordinates with the alternative part using the object scale coordinates of the alternative part and the anchor coordinates of the initial part. As builds are continually developed and various parts are replaced, potential alternative parts that could have been used with an original build may not be compatible with a current build.

In an embodiment, part compatibility is determined using a common three-dimensional coordinate system in which both anchor coordinates and object scale coordinates of the respective part are defined. Each part is modeled within a global or assembly-specific coordinate frame. Within the frame, the anchor coordinates define the intended position and orientation of the part relative to a fixed reference, and the object scale coordinates define the part's outer boundaries, physical extensions and critical dimensions in all three axes. To assess part compatibility, the central server 12 places some or all of the plurality of parts defined by the build code into a coordinate system using the defined anchor coordinates to establish location and orientation. The central server 12 then maps the boundaries of the parts using the object scale coordinates to determine a bounding volume (e.g., bounding box, mesh envelope, or surface map). The central server 12 then compares the bounding volumes of multiple parts within the shared coordinate system. If the mapped boundaries overlap, intersect or violate clearance constraints, the parts are determined to be incompatible. Thus, in various embodiments, compatibility can be determined based on one or more of absence of physical interference (e.g., no overlapping surfaces or bounding boxes), required spatial clearance or tolerance zones, alignment of functional interfaces (e.g., mounting holds, ports), and compliance with regulatory or ergonomic constraints.

In an embodiment, the central server 12 determines the alternative parts available to the user by searching for auto yards 72 and/or auto repair shops 74 that are within a threshold distance of the user terminal 14 using the GPS device 50. In an embodiment, the central server 12 limits display of alternative parts in the panels 84, 86 on the GUI 25 to those available at local auto yards 72 and/or auto repair shops 74 and/or indicates the availability or unavailability of alternative parts based on the search. In an embodiment, the central controller 20 first uses the size/shape of the alternative part to determine whether the alternative part is compatible with the current build being displayed on the GUI 25 of the remote user terminal 14, and then searches availability of only the alternative parts that are determined to be compatible. This way, the central server 12 is not performing unnecessary processing searching for parts that are determined to be incompatible.

At step 112, the central server 12 presents the user U with a list of the alternative/replacement parts. The list of alternative parts can include the selected initial part and the replacements parts that are compatible with the initial part. In FIG. 6, GUI 25 presents the user U with a plurality of alternative wheel part options across the second selection panel 86 since the user U has selected “Wheels” as the initial part to be replaced using the first selection panel 84. As seen in FIG. 7, the user U can further adjust the GUI 25 to receive more detail about the potential alternative parts.

At step 114, the central server 12 receives a second user input regarding a modification to the current build being displayed on the GUI 25 of the remote user terminal 14. In the illustrated embodiment, the second user input is a user selection of an alternative part which replaces a previous part (initial part that can be an original part or a previously changed part) on the current build. The user U can select the alternative part, for example, by selecting from the list or from a plurality of icons corresponding to the plurality of alternative parts. In FIG. 6, the user U selects the alternative Wheel part by selecting one of the wheel options presented in the second selection panel 86. In an embodiment, the GUI 25 informs the user U of compatibility or incompatibility with the current build upon selection by the user U.

At step 116, the central server 12 determines the anchor coordinates for where the initial part attaches to another part. As discussed above, the anchor coordinates can include X, Y and Z coordinates defining where the initial part attaches to at least one other part. The anchor coordinates can include X, Y and Z coordinates for multiple locations where the initial part attaches to multiple other parts.

At step 118, the central server 12 alters the build code to create a cloned scene including the alternative part. More specifically, the central server 12 temporarily creates a new build code which replaces the parts code for the initial part with the parts code for the alternative part. That is, the central server 12 deletes the parts code for the initial part from the build code and adds the parts code for the alternative part into the build code at the location where the parts code for the initial part was deleted. When the central server 12 changes the build code, the central server 12 uses the same anchor coordinates from parts code for the initial part as the anchor coordinates for the parts code for the alternative part. In an embodiment, the central server 12 stores the new build code (e.g., cloned scene) as a temporary file.

FIG. 8 illustrates an example embodiment of a list of identifiers for different parts, and FIG. 9 illustrates an example embodiment of coding to replace an initial part with an alternative part in the build code. In the illustrated embodiment, the coding preserves the identifier (e.g., name) of the initial part when adding the alternative part into the build (cloned scene). Preserving the identifier in this way enables the user U to make additional changes to the current build on the GUI 25 without complicating the build code. As seen in FIG. 8, in the illustrated embodiment, the central server 12 finds the initial part in the cloned scene, preserves the initial part identifier, removes the initial part from the cloned scene and adds the alternative part into the cloned scene in place of the initial part. The cloned scene is thus a modified build code including the alternative part in place of the initial part.

At step 120, the central server 12 regenerates a modified virtual three-dimensional build of the vehicle on the GUI 25 of the user terminal 14 using the altered build code from the cloned scene. The modified virtual three-dimensional build shown on the GUI 25 shows the alternative part in place of the previous part. The user U can also choose to save the new build with the alternative part. The central controller 20 then stores the new build code in the build database 62 so that the user U can access the modified design from the build database 62. The central controller 20 replaces the previous builds code in the build database 62 with the modified build code of the cloned scene. If an initial build with the initial part was user to perform the method 100, then the central server 12 stores the new build code for the alternative build. In an embodiment, the central server 12 access the build code currently stored in the build database 62, deletes the parts code for the part that has been removed, adds the parts code for the alternative part at the same location where the parts code for the removed part was deleted, and uses the same anchor coordinates from the removed part in the parts code for the alternative part. Due to the way the build code and parts codes are generated and stored, memory is conserved and processing proceeds more efficiently versus standalone code for each alteration.

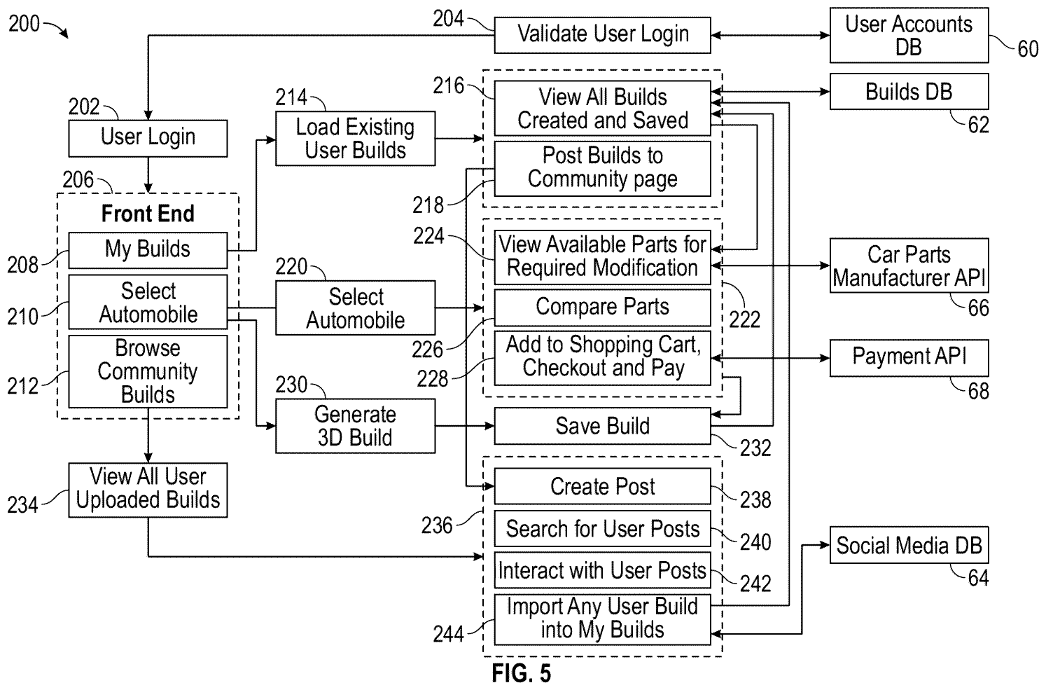

FIG. 5 illustrates another example embodiment of a method 200 for generating and storing alternative three-dimensional vehicle models in accordance with the present disclosure. The method 200 can be implemented by the system 10 described herein. In an embodiment, one or more of the steps of the method 200 can be stored as instructions on the central memory 22 and executed by the central processor 20. In an embodiment, one or more of the steps of the method 200 can be stored as instructions on the terminal memory 32 and executed by the terminal processor 30. It should be understood by those of ordinary skill in the art from this disclosure that some of the steps described herein can be reordered or omitted without departing from the spirit or scope of method 200. FIGS. 6 and 7 further illustrate example embodiments of GUIs 25 generated on a user terminal during the method 200, and FIGS. 8 and 9 further illustrate example embodiments of how to execute certain steps of the method 100.

At step 202, the user U logs into the application A using the GUI 25. When the user U logs into the application A, the system 10 validates the user login at step 204 by accessing the user accounts database 60 and confirming that a username and account password entered at step 202 match a username and account password in the user accounts database 60. The user accounts database 60 can also include encoding for access to one or more builds from the build database. Once the user U has logged in, the user U can access the front-end functionality of the application A.

At step 206, the user U can access the front-end functionality of the application A, for example, by viewing the user U's builds that have each been saved as a build code in the build database 62. More specifically, at step 208 the user U can view the user U's builds which are saved and encoded in the build database 62, at step 210 the user U can select a vehicle and/or create a build that has not been previously saved in the build database 62, or at step 212 the user U can browse community builds saved in the social media database 64.

At step 208, the user U selects to view builds previously saved by the user U. The central server 12 then loads the user U's existing builds at step 214, for example, by loading an index of the user U's builds each stored as a build code from the build database 62. At step 216, the user U can view the index of builds corresponding to the user U's account. At step 218, the user U can also post one or more of the user U's builds to a community page which can be viewed, saved and modified by other users U.

At step 210, the user U selects a vehicle. The user U can select the vehicle, for example, by year, make and model as seen in FIGS. 6 and 7. The central server 12 then loads the vehicle and/or an index of parts for the vehicle at step 220. Once the vehicle is loaded, the user U can view available parts for purchase at step 224, compare the available parts for purchase at step 126, and/or purchase available parts at step 228 via a third-party payment API 68. If the user U has a customized build at step 216, the user U is able to view available parts for a required modification at step 224.

FIG. 6 illustrates an example embodiment of a user interface 25 in which a user U has chosen to load his or her own build at step 214 or select a vehicle at step 220. In the illustrated embodiment, the saved or selected vehicle is a 2015 Ford Mustang GT. The user U has selected the vehicle by choosing the make, model and year from the drop-down menu 80 on the GUI 25. The user U can also view available parts at the bottom of the user interface (step 224) as discussed above. In the illustrated embodiment, the parts are divided by categories (e.g., exterior, interior, performance, wheels, tires, suspension, miscellaneous). The user can select from these categories from a first selection bar panel 84 to view a wide variety of parts available for purchase from different retailers in a second selection panel 86. Here, the user has chosen the “Wheels” category to reveal wheels of different types and prices that are available for purchase from different retailers. In an embodiment, selecting one of the parts from the second selection panel 86 causes the build to regenerate with the part so that the user U can view what the vehicle would look like with the selected part as described above. As shown in FIG. 7, the user U can also compare the specifications of the available parts (step 226).

FIG. 7 further shows an adjusted horsepower calculation for an alternative part. In an embodiment, the central server 12 is configured to calculate adjustments to parameters of the modified vehicle using the alternative part. The parameters can be, for example, horsepower, torque, fuel efficiency, drag, weight distribution or other parameters. The central server 12 can recalculate the parameters using known specifications of the alternative part. Each part within the build can be associated with a parameter profile including physical and performance-related attributes. In an embodiment, when an alternative part is substituted into the three-dimensional model, the central server 12 can automatically trigger a recalculation routine based on an anchor coordinate and/or object scale coordinate evaluation which determines how physical dimensions affect air flow paths, weight distribution, volume constraints, etc. This determination can further be used to recalculate horsepower, torque, fuel efficiency, etc., for example, based on revised airflow and/or mass and aerodynamic changes. In an embodiment, if an alternative part exceeds a predefined threshold related to one of the recalculated parameters, the central server 12 can issue a warning or determine the alternative part to be incompatible with the current build.

In an embodiment, the GUI 25 can also present the user U with other features of the alternative part. In an embodiment, the system 10 stores audio files related to noises made by the alternative part and/or modified build with the alternative part, and the GUI can play the audio file for the user U upon selection of the alternative part.

At step 230, the user U can generate a new 3D build. The user U may desire a new 3D build to model after their own vehicle. The user U can generate a new 3D build by choosing the make, model and year from the drop down menu 80 at the top of the GUI 25 as shown in FIG. 6. The user U can also modify the build to reflect modifications to the user's own vehicle using the method 100 discussed above. In an embodiment, the user U can modify the build by identifying parts that are different from the original model. At step 232, the 3D build is saved to the user U's index of builds in the build database 32.

When a user U creates a new build to reflect his or her own real vehicle, the user U may not know what modifications have been made to the real vehicle. In an embodiment, the user U can take photographs using the camera 48 of the user terminal 14 and upload the photographs to the central server 12. The central server 12 can then compare the photographs to the other uploaded builds to direct the user U to one or more build or parts that corresponds to the parts shown in the photographs. The user U can then import that build into their build database 62 and use the updated build database 62 to run a more refined search for an alternative part. The central server 12 can process the photographs using a neural network to identify modifications that have been made to the vehicle.

At step 212, the user U can browse community builds. The central server 12 accesses the uploaded builds of other users at step 234. At step 236, the user U can create a post at step 238, search for user posts at step 240, interact with user posts at step 242, or import another user build into the user U's builds at step 244.

In an embodiment, a method for enabling vehicle modifications and repairs includes receiving a first user input regarding a vehicle from a remote user terminal 14 operated by a remote user (e.g., at step 214 or step 120), generating a virtual three-dimensional build of the vehicle on a user interface of the remote user terminal 14 (e.g., at step 216 or step 230), receiving a second user input from the remote user terminal regarding at least one modification to the vehicle using an alternative part which replaces a previous part on the vehicle (e.g., at step 216, step 224), regenerating a modified virtual three-dimensional build of the vehicle on the user interface of the user terminal (e.g., step 216, step 224 or step 230), the modified virtual three-dimensional build showing the alternative part in place of the previous part, adjusting parameters stored in a build database replace previous coding for the previous part with replacement coding for the alternative part (e.g., at step 216, step 226 or step 230), using the replacement coding to search for availability of the alternative part for purchase (e.g., at step 226), and/or enabling purchase of the alternative part by the user using the user terminal (e.g., at step 228).

Referring again to FIG. 1, the systems and methods disclosed herein are further advantageous in enabling a user to locate, purchase and/or create the alternative parts. As seen in FIG. 1, the system 10 can include one or more of an auto yard 72, an auto repair shop 74 and a 3D printer 76.

In an embodiment, the system 10 enables a user U to search auto yards 72 for the alternative part after viewing and/or ensuring compatibility of the alternative part on the GUI 25. In an embodiment, the auto yards 72 can access and update the system 10 regarding which parts are available for sale and the price of the parts. When a user U views the modified build including the alternative part on the GUI 25, the user U can be presented with an option to search auto yards 72 for the part. In an embodiment, the system 10 searches for auto yards 72 with the part that are within a predetermined distance of the user terminal 14 as determined by data from the GPS device 50. In an embodiment, the user U can use the payment API 68 to purchase the part from an auto yard 72.

In an embodiment, the system 10 enables a user U to search for auto repair shops 74 capable of installing the alternative part after viewing and/or ensuring compatibility of the alternative part on the GUI 25. In an embodiment, the auto repair shops 74 can access and update the system 10 regarding which repairs can be performed and the price of repairs. When a user U views the modified build including the alternative part on the GUI 25, the user U can be presented with an option to search for local repair shops capable of installing the alternative part. In an embodiment, the system 10 searches for auto repair shops 74 that are within a predetermined distance of the user terminal 14 as determined by data from the GPS device 50. In an embodiment, the user U can use the payment API 68 to set up service by the auto repair shop 74.

In an embodiment, the system 10 is configured to create the alternative part using a 3D printer 76 after viewing and/or ensuring compatibility of the alternative part on the GUI 25. When a user U views the modified build including the alternative part on the GUI 25, the user U can be presented with an option to create the alternative part. In an embodiment, the system 10 stores CAD or other 3D printing files for each part and sends the files to the 3D printer upon the user choosing to create the alternative part. In an embodiment, the system 10 uses the object scale coordinates in the part code to create instructions for 3D printing the part. In an embodiment, the user U can use the payment API 68 to pay for creation of the alternative part. In an embodiment, the system 10 can include a plurality of 3D printers, and the system 10 searches for the closest 3D printer capable of creating the alternative part as determined by data from the GPS device 50 of the user terminal 14.

In an embodiment, a computer-implemented method of training a neural network to identify vehicle modifications includes receiving one or more first digital images from the camera 48 that captures one or more original parts of a vehicle, receiving one or more second digital images from the camera 38 that captures one or more modified parts that replace the one or more original parts of the vehicle, creating a first training set comprising the one or more first digital images, training the neural network in a first stage using the first training set, creating a second training set comprising the one or more second digital images, and training the neural network in a second stage using the second training set.

In an embodiment, the system 10 includes a neural network trained to recognize, classify and optionally segment vehicle parts based on image data from the camera 38. The neural network can be trained on a labeled dataset (e.g., first or second training set) including one or more of photographs of individual parts from multiple angles, images of parts installed in vehicle assemblies, environmental variations and backgrounds ranging from a generally clean garage environments to more complex field environments. Each image can be annotated with metadata including the part name or identifier, the part number, the vehicle make, model or year, the orientation and bounding box coordinates, and optional segmentation masks or key point data. The neural network is then trained using the labeled dataset as the input training data. The neural network is trained to output identification of one or more parts stored by the database 26 using the input data. Upon identification, the system 10 is configured to alter a build code with the identified one or more parts and to present the altered build code to the user U as described above. In an embodiment, if confidence is below a threshold, the system 10 can request that the user U take additional photographs with the camera 48.

In an embodiment, the virtual three-dimensional build created in accordance with the methods described herein can be rendered in real-time through an augmented reality (AR) interface, such as an AR headset or a user terminal 14 with camera 48 and depth sensing capabilities. When viewed through the AR device, the model is overlaid onto the user's physical environment, allowing the user to examine the modified build including the alternative part from multiple angles by moving around or zooming in. This enables users a closer look at features such as fasteners, mounting points or electrical connectors without requiring physical access to the alternative part. In an embodiment, this feature can also be used to assist the user U in installing the part on the real vehicle upon acquiring the alternative part after full analysis using the methods described herein.

The systems and methods described herein are advantageous for enabling vehicle modifications and parts purchasing. The disclosed systems and methods are particularly advantageous in reducing processing resources and memory storage through the creation and application of the databases and functionality described herein. It should be understood that various changes and modifications to the methods described herein will be apparent to those skilled in the art and can be made without diminishing the intended advantages,

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A method for generating modified virtual three-dimensional builds of vehicles, the method comprising:
receiving a first user input regarding a vehicle from a remote user terminal operated by a remote user;
generating a virtual three-dimensional build of the vehicle on a user interface of the remote user terminal using a build code including a plurality of parts codes;
receiving a second user input from the remote user terminal regarding at least one modification to the virtual three-dimensional build using an alternative part which replaces a current part on the vehicle;
altering the build code by replacing a current parts code for the current part with an alternative parts code for the alternative part;
regenerating a modified virtual three-dimensional build on the user interface of the user terminal using the altered build code, the modified virtual three-dimensional build showing the alternative part in place of the current part.

2. The method of claim 1, wherein
the current parts code for the current part includes an anchor coordinate.

3. The method of claim 2, wherein
the alternative parts code for the alternative part includes the same anchor coordinate.

4. The method of claim 1, wherein
the plurality of parts codes include anchor coordinates and object scale coordinates for a plurality of parts included in the build code.

5. The method of claim 1, comprising
storing the altered build code as a temporary file when regenerating the modified virtual three-dimensional build on the user interface.

6. The method of claim 1, comprising
determining whether the alternative part is compatible with the virtual three-dimensional build of the vehicle using uses a size of the alternative part.

7. The method of claim 1, comprising
determining whether the alternative part is compatible with the virtual three-dimensional build of the vehicle using an anchor coordinate of the current part.

8. The method of claim 1, comprising
determining whether other parts in the build code have overlapping coordinates with the alternative part.

9. A system programmed to execute the method of claim 1.

10. A method for generating modified virtual three-dimensional builds of vehicles, the method comprising:
generating a virtual three-dimensional build of a vehicle on a user interface of a remote user terminal using a build code including a plurality of parts codes, the plurality of parts codes including an anchor coordinate and an object scale coordinate;
determining a plurality of alternative parts that can replace a current part using the anchor coordinate of the current part and the object scale coordinate of the alternative part;
enabling selection of the plurality of alternative parts along the virtual three-dimensional build of the vehicle;
upon selection of one of the plurality of alternative parts, regenerating a modified virtual three-dimensional build on the user interface, the modified virtual three-dimensional build showing the alternative part in place of the previous part.

11. The method of claim 10, comprising
altering the build code by replacing a current parts code for the current part with an alternative parts code for the alternative part.

12. The method of claim 10, comprising
determining a user terminal location using a GPS device on the user terminal and searching for the alternative part within a threshold distance of the user terminal location.

13. The method of claim 10, wherein
the anchor coordinate includes an X coordinate, a Y coordinate and a Z coordinate.

14. The method of claim 10, wherein
the object scale coordinate includes an X coordinate, a Y coordinate and a Z coordinate.

15. The method of claim 10, wherein
determining the plurality of alternative parts that can replace the current part using the anchor coordinate of the current part and the object scale coordinate of the alternative part includes determining whether other parts in the build code have overlapping coordinates with the alternative part.

16. A system programmed to execute the method of claim 10.

17. A method for generating modified virtual three-dimensional builds of vehicles, the method comprising:
receiving a first user input regarding a vehicle from a remote user terminal operated by a remote user;
generating a virtual three-dimensional build of the vehicle on a user interface of the remote user terminal using a build code from a build database;
receiving a second user input from the remote user terminal regarding at least one modification to the virtual three-dimensional build using an alternative part which replaces a current part on the vehicle;
regenerating a modified virtual three-dimensional build of the vehicle on the user interface of the user terminal, the modified virtual three-dimensional build showing the alternative part in place of the current part;
replacing the build code in the build database with an altered build code including a parts code for the alternative part;
searching for availability of the alternative part for purchase; and
enabling purchase of the alternative part by the user using the user terminal.

18. The method of claim 17, comprising
determining a user terminal location using a GPS device on the user terminal and searching for the alternative part within a threshold distance of the user terminal location.

19. The method of claim 17, comprising
determining a plurality of alternative parts that can replace the current part using an anchor coordinate of the current part and an object scale coordinate of the alternative part.

20. A system programmed to execute the method of claim 17.
